(19) United States
(12) Patent Application Publication
(10) Pub. No.: US 2018/0348569 A1
(43) Pub. Date: Dec. 6, 2018

(54) DISPLAY PANEL

(71) Applicant: AU OPTRONICS CORPORATION, Hsin-chu (TW)

(72) Inventor: Ju-Chin CHEN, Hsin-chu (TW)

(21) Appl. No.: 15/995,434

(22) Filed: Jun. 1, 2018

(30) Foreign Application Priority Data
Jun. 5, 2017 (TW) 106118581

(51) Int. Cl. G02F 1/1335; G02F 1/1333

(52) U.S. Cl. CPC G02F 1/133512; G02F 1/133514; G02F 2201/123; G02F 1/133305; G02F 2201/121; G02F 1/133345

(57) ABSTRACT

A display panel includes a substrate, a pixel unit and a light shielding unit. The substrate has a curved surface. The curved surface has a curvature center axis. A mid-line is defined on the curved surface and is parallel to the curvature center axis. A first compensation region located on a side of the mid line is defined on the substrate. The pixel unit is located in the first compensation area of the substrate. A light shielding unit is located on the substrate and includes a first light shielding sub-unit, located on a side edge of a first color sub pixel unit, and a second light shielding sub-unit, located on a side edge of a second color sub pixel unit. In the first compensation area, a width of the first light shielding sub-unit is not equal to a width of the second light shielding sub-unit.

### CROSS-REFERENCE TO RELATED PATENT APPLICATION

This non-provisional application claims priority to and the benefit of, pursuant to 35 U.S.C. § 119(a), patent application Serial No. 106118581 filed in Taiwan on Jun. 5, 2017. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a display panel, and in particular, to a display panel provided with a light shielding layer.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

With the progress of display technologies, curved displays or flexible displays are increasingly popular. Compared with the past flat displays, curved displays or flexible displays can provide more viewing angles, or are applicable to products of more types. However, for the curved display, when an user squarely faces the curved display, assuming that a front view line of sight is defined to correspond to a mid line of the curved display, effective cell gaps of the curved surface are relatively small at positions close to the mid line, and effective cell gaps of the curved display are relatively large at positions far from the mid line. The effective cell gap refers to a gap or the thickness of a cell of a display in a direction parallel to the line of sight. Non-uniform effective cell gaps cause color shift to easily occur in a large viewing angle area of a curved display or a flexible display. Generally, the large viewing angle area of the curved display or flexible display easily becomes yellow, and consequently, the visual experience of a user is affected.

### SUMMARY

The present invention is to provide a plurality of display panels to overcome the problem of color shift easily occurring in a large viewing angle area of a curved display or a flexible display.

The present invention discloses a display panel, including a substrate, a pixel unit, and a light shielding unit. The substrate includes a curved surface, and the curved surface has a curvature center axis. In addition, a mid line is defined on the curved surface. The mid line is parallel to the curvature center axis. In addition, a first compensation area located on a side of the mid line is defined on the substrate. The pixel unit is located in the first compensation area of the substrate. The pixel unit includes a first color sub pixel unit and a second color sub pixel unit. The light shielding unit is located on the substrate. The first light shielding sub-unit is located on a side edge, far from the mid line, of the first color sub pixel unit. The second light shielding sub-unit is located on a side edge, far from the mid line, of the second color sub pixel unit. In the first compensation area, the width of the first light shielding sub-unit is not equal to the width of the second light shielding sub-unit.

The present invention discloses another display panel, including a substrate, a plurality of pixel units, and a plurality of light shielding units. An equivalent front view area, a first compensation first sub area, and a first compensation second sub area are defined on the substrate. The equivalent front view area is located between the first compensation first sub area and the first compensation second sub area. Each pixel unit is located on the substrate. Each pixel unit includes a first color sub pixel unit and a second color sub pixel unit. The light shielding units are disposed on the substrate. Each light shielding unit is disposed corresponding to a pixel unit. Each light shielding unit includes a first light shielding sub-unit and a second light shielding sub-unit. The first light shielding sub-unit and the second light shielding sub-unit are respectively located on a side edge of the first color sub pixel unit and a side edge of the second color sub pixel unit. In a light shielding unit of the first compensation first sub area and in a light shielding unit of the first compensation second sub area, the width of the first light shielding sub-unit is not equal to the width of the second light shielding sub-unit. The first light shielding sub-units are respectively located on side edges, far from the equivalent front view area, of the first color sub pixel units, and the second light shielding sub-units are respectively located on side edges, far from the equivalent front view area, of the second color sub pixel units. In a light shielding unit of the equivalent front view area, the width of the first light shielding sub-unit is substantially equal to the width of the second light shielding sub-unit.

Based on the above, the present invention provides a plurality of display panels. By disposing a light shielding unit on a substrate, the light shielding unit includes a first light shielding sub-unit and a second light shielding sub-unit. The first light shielding sub-unit and the second light shielding sub-unit are respectively located on a side edge, far from a mid line, of a first color sub pixel unit and a side edge, far from the mid line, of a second color sub pixel unit. In addition, in a first compensation area, the width of the first light shielding sub-unit is not equal to the width of the second light shielding sub-unit, to separately adjust the amount of light that passes through different sub pixel units. In this way, the problem that color shift easily occurs in a large viewing angle area of a curved display or a flexible display is avoided.

These and other aspects of the present disclosure will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1A is a schematic diagram of a display panel according to an embodiment of the present invention.

FIG. 1B is a schematic diagram of a display panel according to another embodiment of the present invention.

FIG. 1C is a detailed schematic diagram of the display panel according to FIG. 1A of the present invention.

FIG. 1D is a schematic diagram of a curved surface of the display panel according to FIG. 1C.

FIG. 2 is a schematic top view of one pixel unit of a display panel according to an embodiment of the present invention.

FIG. 3A is a schematic diagram of a display panel relative to a line-of-sight of a user according to an embodiment of the present invention.

FIG. 3B is a schematic cross-sectional view of one pixel unit of the display panel according to this embodiment of the present invention.

FIG. 3C is a schematic cross-sectional view of the other pixel unit of the display panel according to this embodiment of the present invention.

FIG. 4A is a schematic top view of one pixel unit of a display panel according to another embodiment of the present invention.

FIG. 4B is a schematic top view of one pixel unit of a display panel according to still another embodiment of the present invention.

FIG. 4C is a partial schematic cross-sectional view of a 4C-4C cross section of the display panel according to FIG. 4B.

FIG. 4D is a schematic top view of one pixel unit of a display panel according to still yet another embodiment of the present invention.

FIG. 4E is a schematic top view of one pixel unit of a display panel according to a still further embodiment of the present invention.

FIG. 5A is a schematic top view of one pixel unit of a display panel according to another embodiment of the present invention.

FIG. 5B is a schematic top view of one pixel unit of a display panel according to still another embodiment of the present invention.

FIG. 5C is a partial schematic cross-sectional view of a 5C-5C cross section of the display panel according to FIG. 5B.

FIG. 6A is a schematic top view of one pixel unit of a display panel according to still yet another embodiment of the present invention.

FIG. 6B is a partial schematic cross-sectional view of a 6B-6B cross section of the display panel according to FIG. 6A.

FIG. 7 is a schematic diagram of a curve surface of a display panel according to another embodiment of the present invention.

FIG. 8A is a schematic diagram of a light shielding unit corresponding to an equivalent front view area according to FIG. 7.

FIG. 8B is a schematic diagram of a light shielding unit corresponding to a first compensation first sub area according to FIG. 7.

FIG. 8C is a schematic diagram of a light shielding unit corresponding to a first compensation second sub area according to FIG. 7.

FIG. 8D is a schematic diagram of a light shielding unit corresponding to a second compensation first sub area according to FIG. 7.

FIG. 8E is a schematic diagram of a light shielding unit corresponding to a second compensation second sub area according to FIG. 7.

FIG. 9A is a schematic diagram of a display panel according to another embodiment of the present invention.

FIG. 9B is a schematic diagram of a curved surface of the display panel according to FIG. 9A.

### DETAILED DESCRIPTION

The detailed features and advantages of the present invention are described below in great detail through the following embodiments, and the content of the detailed description is sufficient for persons skilled in the art to understand the technical content of the present invention and to implement the present invention there accordingly. Based upon the content of the specification, the claims, and the drawings, persons skilled in the art can easily understand the relevant objectives and advantages of the present invention. The following embodiments further describe the viewpoints of the present invention, but are not intended to limit the scope of the present invention in any way.

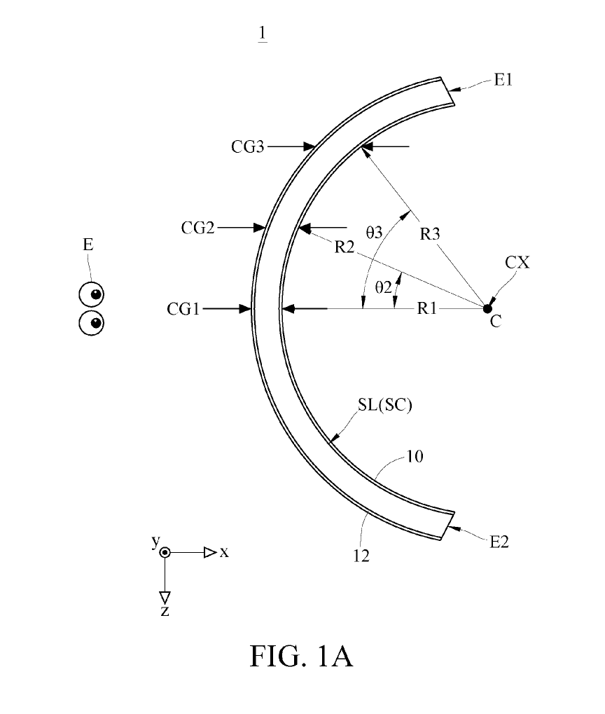

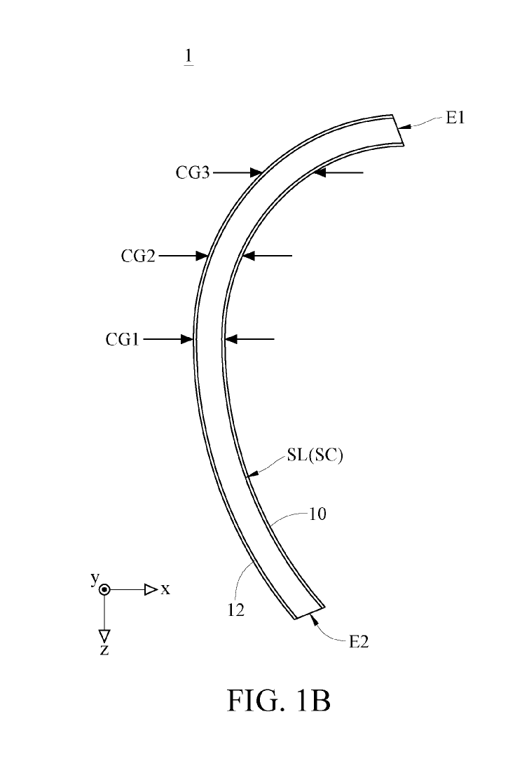

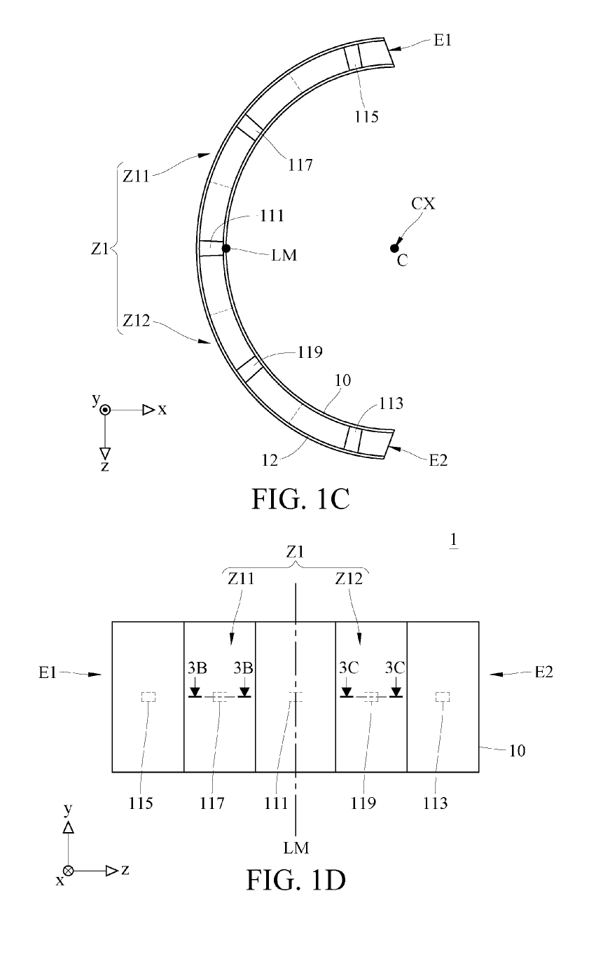

Referring to FIG. 1A to FIG. 1D, FIG. 1A is a schematic diagram of a display panel according to an embodiment of the present invention; FIG. 1B is a schematic diagram of a display panel according to another embodiment of the present invention; FIG. 1C is a detailed schematic diagram of the display panel according to FIG. 1A of the present invention; and FIG. 1D is a schematic diagram of a curved surface of the display panel according to FIG. 1C. A display panel 1 includes an opposite substrate 12, a substrate 10, a first signal line, a second signal line, a common signal line, at least one pixel unit, and at least one light shielding unit. The first signal line, the second signal line, the common signal line, the at least one pixel unit, and the at least one light shielding unit are described later. A first end E1 and a second end E2 and corresponding coordinate axis directions are marked in FIG. 1A to FIG. 1D, to show corresponding azimuths of the display panel 1 in FIG. 1A to FIG. 1D.

The substrate 10 includes an upper surface SL, which is a curved surface SC. The curved surface SC has a curvature center C. There is a curvature radius between the curved surface SC and the curvature center C, and curvature radiuses R1 to R3 are illustrated in FIG. 1. The curvature radiuses R1 to R3 may be the same or different. An embodiment in which the curvature radiuses R1 to R3 are the same is shown in FIG. 1A, and an embodiment in which the curvature radiuses R1 to R3 are different are shown in FIG. 1B. The embodiment shown in FIG. 1A is subsequently described. However, a person of ordinary skilled in the art can derive an implementation aspect of FIG. 1B from the description of FIG. 1A.

A mid line LM is defined on the curved surface SC. The mid line LM is parallel to a curvature center axis CX (shown in FIG. 1A and FIG. 1C). A curvature center axis CX is a virtual line that passes through the curvature center C and along a y axis direction, and is perpendicular to the curvature radius R. From another perspective, the curvature center axis CX is perpendicular to each curvature radius.

As shown in FIG. 1A, effective cell gaps exist between the substrate 10 and the opposite substrate 12. At different positions, distances of the effective cell gaps are also different. As regards effective cell gaps CG1 to CG3, the distance of the effective cell gap CG1 is less than the distance of the effective cell gap CG2, and the distance of the effective cell gap CG2 is less than the distance of the effective cell gap CG3. Therefore, that is, an effective cell gap closer to the mid line LM indicates a smaller distance of the effective cell gap, and an effective cell gap farther from the mid line LM indicates a larger distance of the effective cell gap. On the other hand, from the perspective of a viewing angle, when an extension direction of the curvature radius R1 is used as reference, the effective cell gap CG1, the effective cell gap CG2, and the effective cell gap CG3 substantially correspond to different viewing angles. Specifically, the effective cell gap CG1 corresponds to a viewing angle of 0 degrees; the effective cell gap CG2 corresponds to a viewing angle θ2; and the effective cell gap CG3 corresponds to a viewing angle θ3. The viewing angle θ2 is less than the viewing angle θ3, and the viewing angle corresponding to the effective cell gap CG1 is less than the viewing angle θ2. However, as regards the position relative to human eyes, a viewing angle may be defined as an upper viewing angle, a lower viewing angle, a left viewing angle, or a right viewing angle. By using FIG. 1A as an example, the viewing angle θ2 and the viewing angle θ3 may be defined as right viewing angles. When there is a large viewing angle, the problem of color shift easily occurs if a design of a conventional flat display panel is used. A viewing angle may be freely defined by a person of ordinary skill in the art after the person reads this specification in detail, and only illustration is performed herein, and this application is not limited thereto.

On the other hand, as shown in FIG. 1C and FIG. 1D, for ease of description, in this embodiment, the mid line LM is located at a position that passes through a middle point between the first end E1 and the second end E2. However, in practice, the position of the mid line LM is defined by a person of ordinary skill in the art according to actual requirements, and does not necessarily pass through the middle point between the first end E1 and the second end E2, and this application is not limited to the example.

In addition, a first compensation area Z1 is defined on the display panel 1. The first compensation area Z1 is located on two sides of the mid line LM. More specifically, the first compensation area Z1 may further be defined as a first compensation first sub area Z11 and a first compensation second sub area Z12. The first compensation first sub area Z11 is located on one side of the mid line LM, and the first compensation second sub area Z12 is located on the other side of the mid line. The display panel 1 includes at least one pixel unit. Pixel units 111, 113, 115, 117, and 119 are shown in FIG. 1C for description. The pixel unit 117 is located in the first compensation first sub area Z11, and the pixel unit 119 is located in the first compensation second sub area Z12. Refer to subsequent description for related details.

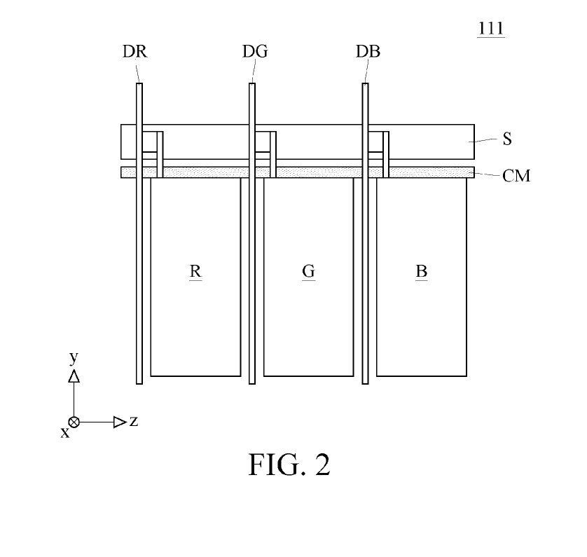

Next, referring to FIG. 2, FIG. 2 is a schematic top view of one pixel unit of a display panel according to an embodiment of the present invention. FIG. 2 is used only for illustration. The sizes or shapes of various elements are not drawn according to the flexibility of the display panel. From another perspective, the pixel unit is relatively small compared with a curved surface SC, and therefore the flexibility of the pixel unit is not considered herein. As shown in FIG. 2, a first signal line S is disposed on a substrate 10 (not shown), for transmitting a gate drive signal. Second signal lines DR, DG, and DB are disposed on the substrate 10 (not shown). The second signal lines DR, DG, and DB are used to transmit data signals, and the second signal lines DR, DG, and DB intersect with the first signal line S. Transistors (not shown) are disposed on the substrate 10, to electrically connect the first signal line S and the corresponding second signal lines. A common signal line CM is disposed on the substrate 10. The common signal line CM is used to transmit a common voltage. An extension direction of the common signal line CM is parallel to an extension direction of the first signal line S, or an extension direction of the second signal lines DR, DG, and DB. In this embodiment, the common signal line CM is parallel to the first signal line S. A pixel unit 111 includes a first color sub pixel unit R and a second color sub pixel unit B. In this embodiment, the pixel unit 111 further includes a third color sub pixel unit G, which is located between the first color sub pixel unit R and the second color sub pixel unit B. The first color sub pixel unit R is used to emit red light; the second color sub pixel unit B is used to emit blue light; and the third color sub pixel unit G is used to emit green light; but this application is not limited thereto. The common signal line CM is a selective design, and a display panel 1 does not necessarily include the common signal line CM.

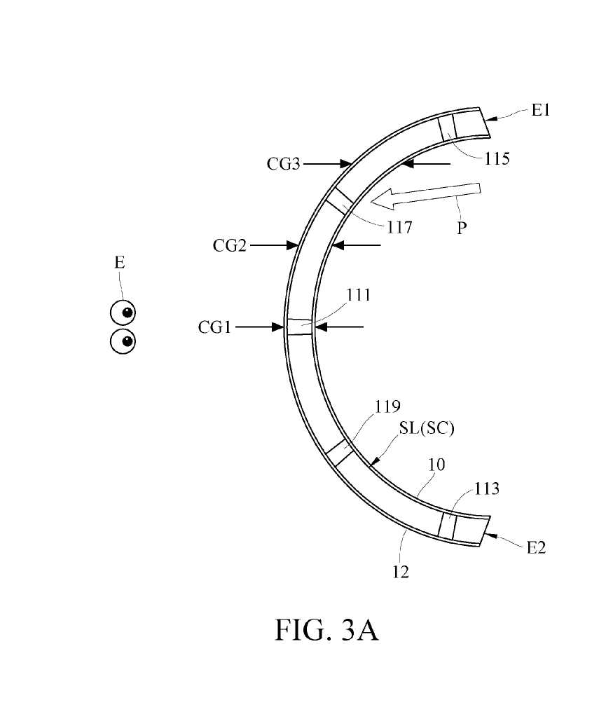

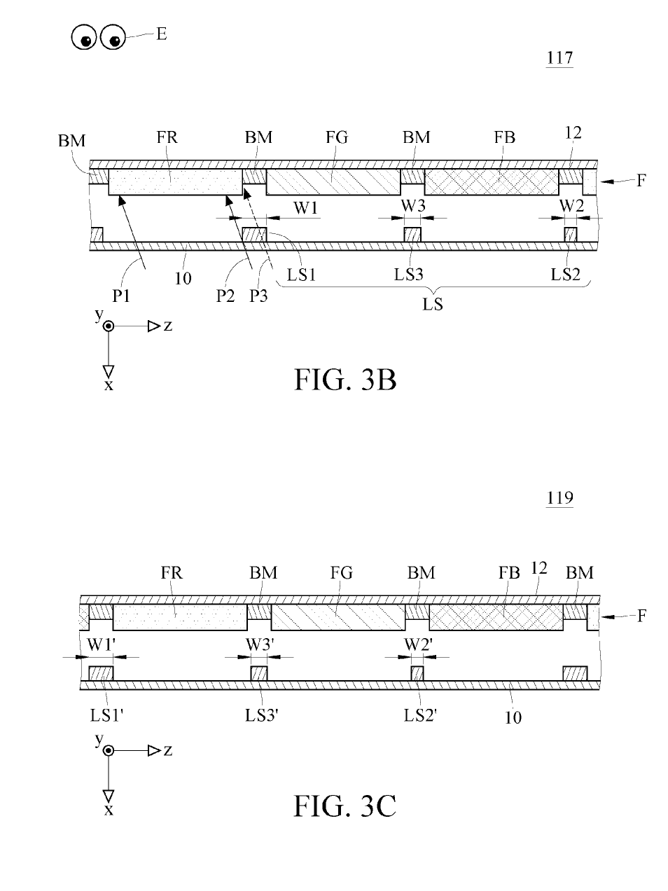

Referring to FIG. 3A, FIG. 3B, and FIG. 3C, FIG. 3A, FIG. 3B, and FIG. 3C are used describe related details of a light shielding unit. FIG. 3A is a schematic diagram of a display panel relative to a line of sight of a user according to an embodiment of the present invention. FIG. 3B is a schematic cross-sectional view of one pixel unit of the display panel according to this embodiment of the present invention. FIG. 3C is a schematic cross-sectional view of the other pixel unit of the display panel according to this embodiment of the present invention. FIG. 3B and FIG. 3C are only used to illustrate the position of the light shielding unit relative to other elements, and a specific implementation aspect of the light shielding unit is described later. FIG. 3B, for example, is used to illustrate a cross section of a pixel unit 117 in FIG. 3A, and refer to a 3B-3B cross-sectional line shown in FIG. 1D for a relative position of the pixel unit 117 in the display panel. FIG. 3C, for example, is used to illustrate a cross section of a pixel unit 119 in FIG. 3A, and refer to a 3C-3C cross-sectional line shown in FIG. 1D for a relative position of the pixel unit 119 in the display panel.

As shown in FIG. 3B, in addition to a substrate 10, a display panel 1 further includes an opposite substrate 12. A filter layer F is disposed on the opposite substrate 12. The filter layer F includes a black matrix BM, a first color filter unit FR, a second color filter unit FB, and a third color filter unit FG. The black matrix BM surrounds the first color filter unit FR, the second color filter unit FB, and the third color filter unit FG. The relative relationships between the black matrix BM and the first color filter unit FR, the second color filter unit FB, and the third color filter unit FG can be derived by a person of ordinary skill in the art, and no limitation is made herein. However, other elements or layers may further be disposed between the substrate 10 and the opposite substrate 12. For ease of description, no more description is made herein.

Referring to FIG. 3B, FIG. 3C, and FIG. 1D at the same time, a light shielding unit LS is disposed on the substrate 10. The light shielding unit LS includes a first light shielding sub-unit LS1 and a second light shielding sub-unit LS2. The first light shielding sub-unit LS1 is located on a side edge, far from a mid line LM, of a first color sub pixel unit R. The second light shielding sub-unit LS2 is located on a side edge, far from the mid line LM, of a second color sub pixel unit B. That is, as shown in FIG. 3B, in a first compensation first sub area Z11, the first light shielding sub-unit LS1 is located on the side edge, far from the mid line LM, of the first color sub pixel unit R; the second light shielding sub-unit LS2 is located on the side edge, far from the mid line LM, of the second color sub pixel unit B. For example, the mid line LM is located on a left side of the pixel unit 117, and each light shielding LS is located on a right side edge of each sub pixel unit. As shown in FIG. 3C, in a first compensation second sub area Z12, a first light shielding sub-unit LS1′ is located on the side edge, far from the mid line LM, of the first color sub pixel unit R; a second light shielding sub-unit LS2′ is located on the side edge, far from the mid line LM, of the second color sub pixel unit B. For example, the mid line LM is located on the right side of the pixel unit 119, and each light shielding LS is located on the left side edge of each sub pixel unit.

As shown in FIG. 3B, in the first compensation first sub area Z11, the width W1 of the first light shielding sub-unit LS1 is greater than the width W2 of the second light shielding sub-unit LS2. As shown in FIG. 3C, in the first compensation second sub area Z12, the width W1′ of the first light shielding sub-unit LS1′ is greater than the width W2′ of the second light shielding sub-unit LS2′. That is, in a first compensation area Z1, the width W1 of the first light shielding sub-unit LS1 is not equal to the width W2 of the second light shielding sub-unit LS2. In this embodiment, the width W1 of the first light shielding sub-unit LS1 is greater than the width W2 of the second light shielding sub-unit LS2.

In this embodiment, the light shielding unit LS further includes a third light shielding sub-unit LS3. The third light shielding sub-unit LS3 is located on a side edge, far from the mid line LM, of a third color sub pixel unit G. That is, as shown in FIG. 3B, in the first compensation first sub area Z11, the third light shielding sub-unit LS3 is located on the side edge, far from the mid line LM, of the third color sub pixel unit G. As shown in FIG. 3C, in the first compensation second sub area Z12, a third light shielding sub-unit LS3′ is located on the side edge, far from the mid line LM, of the third color sub pixel unit G. In the first compensation first sub area Z11, the width W1 of the first light shielding sub-unit LS1 is greater than the width W3 of the third light shielding sub-unit LS3, and the width W3 of the third light shielding sub-unit LS3 is greater than the width W2 of the second light shielding sub-unit LS2. As shown in FIG. 3C, in the first compensation second sub area Z12, the width W1′ of the first light shielding sub-unit LS1′ is greater than the width W3′ of the third light shielding sub-unit LS3′, and the width W3′ of the third light shielding sub-unit LS3′ is greater than the width W2′ of the second light shielding sub-unit LS2′. That is, in this embodiment, in the first compensation area Z1, the width of the first light shielding sub-unit LS1 is greater than the width of the third light shielding sub-unit LS3, and the width of the third light shielding sub-unit LS3 is greater than the width of the second light shielding sub-unit LS2.

Each light shielding sub-unit is at least partially located in an orthographic projection of the black matrix BM on the substrate 10. That is, the light shielding unit LS may be completely located in the orthographic projection of the black matrix BM on the substrate 10, or may exceed the range of the orthographic projection of the black matrix BM on the substrate 10 and is partially located within the range of an orthographic projection of each filter unit F on the substrate 10. The width of the light shielding sub-unit is not limited herein, and any implementation in which a light shielding unit is disposed on a substrate of a display panel to control the amount of light that passes through a filter unit falls within the scope of this application.

However, in FIG. 3A, a wide arrow P is used to show a change of the amount of light provided by a backlight module (not shown), and in FIG. 3B, long arrows P1, P2, and P3 are used to show traveling directions of the light provided by the backlight module. As shown by the wide arrow P in FIG. 3A, a luminous flux of light before the light passes through the pixel unit 117 is different from a luminous flux of the light after the light passes through the pixel unit 117. More specifically, the luminous flux of the light before the light passes through the pixel unit 117 is greater than the luminous flux of the light after the light passes through the pixel unit 117. That is, the pixel unit 117 blocks some light. As shown in FIG. 3B, the long arrows P1 and P2 are solid lines, and are used to represent light that can pass through the first color filter unit FR and can be sensed by human eyes E. The long arrow P3 is a dotted line to represent light that is blocked by the first light shielding sub-unit LS1 and cannot pass through the first color filter unit FR. In other words, by disposing the first light shielding sub-unit LS1 in Z11 and Z12 of the first compensation area, the amount of light that passes through the first color filter unit FR is reduced. As stated above, the first color filter unit FR is used to filter out light other than red light, and therefore, reducing the amount of light that passes through the first color filter unit FR is equivalent to reducing the amount of red light output by the pixel unit 117. Because yellow light is formed by red light and green light, when the red light in the yellow light is weakened, the yellow light is also weakened. Similarly, by disposing the third light shielding sub-unit LS3 in Z11 and Z12 of the first compensation area, the amount of light that passes through the third color filter unit FG is reduced. As stated above, the third color filter unit FG is used to filter out light other than green light, and therefore, reducing the amount of light that passes through the third color filter unit FG is equivalent to reducing the amount of green light output by the pixel unit 117. Because yellow light is formed by red light and green light, when the green light in the yellow light is weakened, the yellow light is also weakened. When areas with relatively large viewing angles are defined as Z11 and Z12 of the first compensation area, and the light shielding unit LS is disposed in Z11 and Z12 of the first compensation area, yellow light output in large viewing angle areas of the display panel 1 can be effectively weakened, so as to overcome the problem that color shift easily occurs in the large viewing angle areas of the display panel 1.

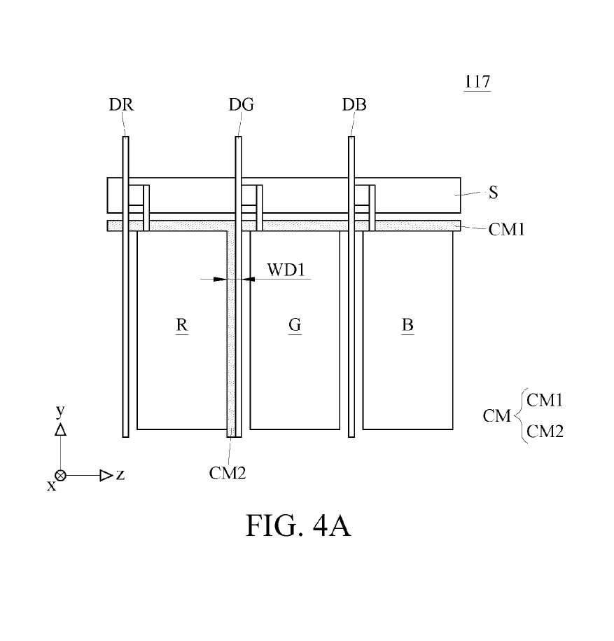

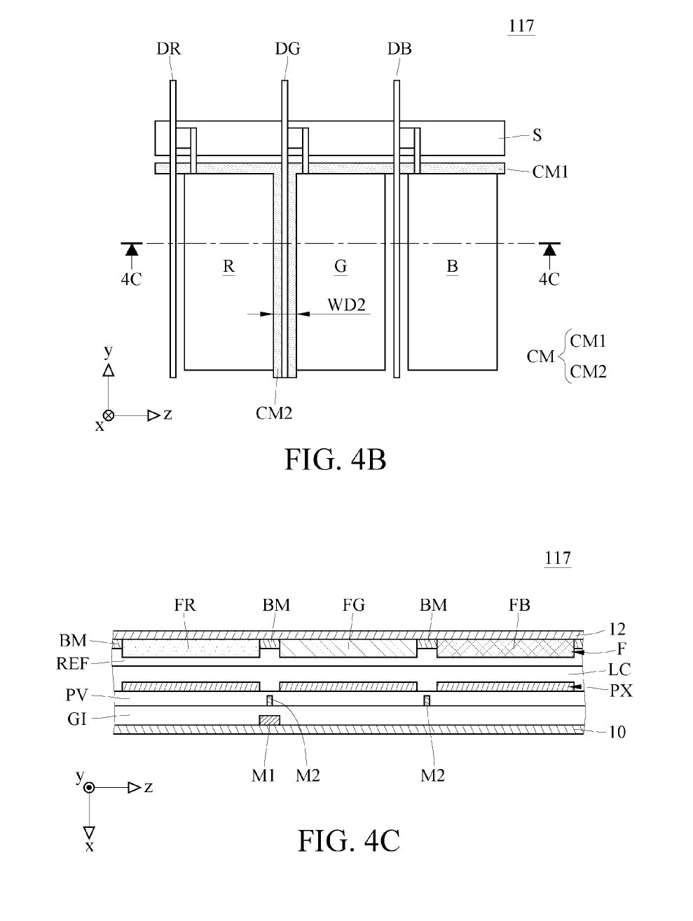

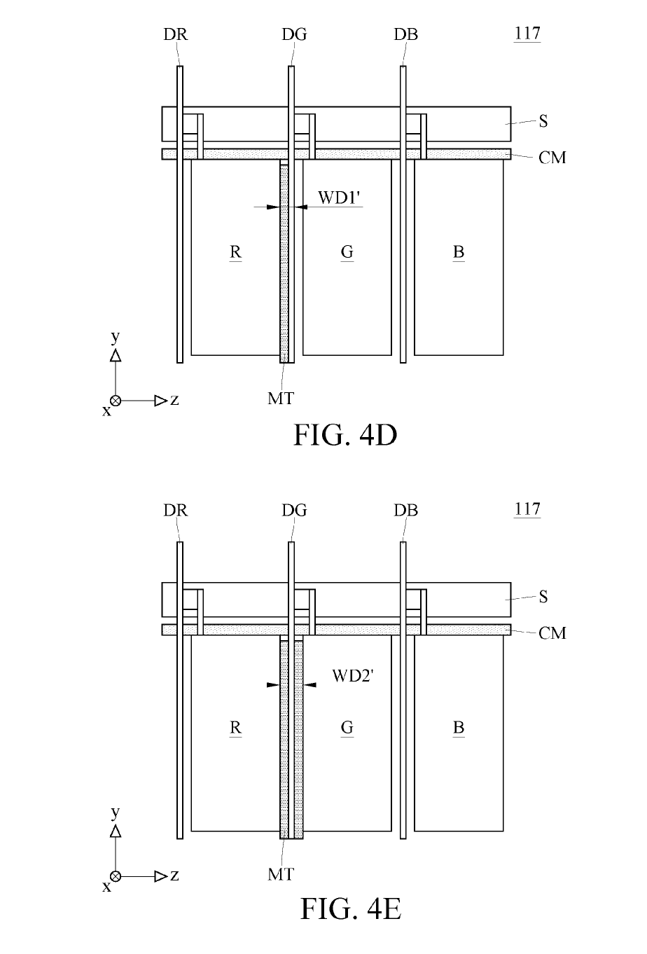

FIG. 4 is used to describe the basic concept of a light shielding unit. A light shielding unit LS may include at least one part of a first signal line S, at least one part of second signal lines DR, DB, and DG, at least one part of a common signal line CM, or a combination thereof, or the light shielding unit LS may be formed in a display panel 1 by using another opaque material. That is, a first light shielding sub-unit LS1 and a second light shielding sub-unit LS2 may be at least one part of the first signal line S, at least one part of the second signal lines DR, DB, and DG, at least one part of the common signal line CM, or a combination thereof. Various combinations of the facts that the light shielding unit LS includes at least one part of the first signal line S, the light shielding unit LS includes at least one part of the second signal lines DR, DB, and DG, and the light shielding unit LS includes at least one part of the common signal line CM, or, the light shielding unit LS is formed in the display panel 1 by using another opaque material are separately described later.

Next, referring to FIG. 4A, FIG. 4B, and FIG. 4C, FIG. 4A, FIG. 4B, and FIG. 4C are used to describe an implementation aspect in which the light shielding unit LS includes a combination of at least one part of the common signal line CM and at least one part of the second signal lines. FIG. 4A is a schematic top view of one pixel unit of a display panel according to another embodiment of the present invention. FIG. 4B is a schematic top view of one pixel unit of a display panel according to still another embodiment of the present invention. FIG. 4C is a partial schematic cross-sectional view of a 4C-4C cross section of the display panel according to FIG. 4B.

In the embodiment shown in FIG. 4A and FIG. 4B, the common signal line CM includes a transmission portion CM1 and a light shielding portion CM2. The transmission portion CM1 extends along a z direction, and is parallel to the first signal line S, and the light shielding portion CM2 is connected to the transmission portion CM1 and extends along a y direction, and is parallel to the second signal line DG. The transmission portion CM1 is used to transmit a common voltage. A light shielding sub-unit includes at least one part of the light shielding portion CM2 of the common signal line CM. The light shielding portion CM2 shown in FIG. 4A and FIG. 4B is one part of the light shielding sub-unit LS1 in FIG. 3. That is, for the embodiment shown in FIG. 4A and FIG. 4B, the light shielding sub-unit LS1 includes the light shielding portion CM2 and at least one part of the second signal line DG. However, the embodiment shown in FIG. 4A differs from the embodiment shown in FIG. 4B in that, in FIG. 4A, in a direction perpendicular to the substrate 10, that is, in the x axis direction, one side of the light shielding portion CM2 aligns to an edge of the first color filter unit FR, and the other side of the light shielding portion CM2 is located between the first color filter unit FR and the third color filter unit FG. Aligning to the edge of the first color filter unit FR refers to align to an edge of an actual light transmittable area of the first color filter unit FR. In some embodiments, the material of the first color filter unit FR may cover the black matrix BM. However, when the area is a non-light-transmittable area, the meaning of subsequently mentioned aligning to is the same as above, and details are not repeated. However, in FIG. 4B, in the x axis direction, one side of the light shielding portion CM2 aligns to the edge of the first color filter unit FR, and the other side of the light shielding portion CM2 aligns to an edge of the third color filter unit FG. From another perspective, if a mid line between the adjacent first color filter unit FR and the third color filter unit FG is the symmetric axis, the light shielding portion CM2 in FIG. 4A is not symmetric about the symmetric axis, and the light shielding portion CM2 in FIG. 4B is symmetric about the symmetric axis. In FIG. 4A, the light shielding sub-unit LS1 has a width WD1, and in FIG. 4B, the light shielding sub-unit LS1 has a width WD2. From another perspective, the width WD1 and the width WD2 are lengths of the light shielding sub-unit in the z axis direction.

FIG. 4C shows an array cell structure (AC structure) of the display panel in this embodiment by using the 4C-4C cross section in FIG. 4B. A substrate 10, a first conductor layer M1, an insulation layer GI, a second conductor layer M2, an insulation layer PV, a pixel electrode layer PX, a liquid crystal layer LC, a common electrode layer REF, a filter layer F, and an opposite substrate 12 are shown in FIG. 4C.

The first conductor layer M1 is disposed on the substrate 10. The first conductor layer M1 includes a first signal line S and a common signal line CM. The insulation layer GI is disposed on the substrate 10 and on the first conductor layer M1. The insulation layer GI covers at least one part of the light shielding portion CM2. The second conductor layer M2 is disposed on the insulation layer GI, and the second conductor layer M2 includes second signal lines DR, DG, and DB. The insulation layer PV is disposed on the insulation layer GI and on the second conductor layer M2. The insulation layer PV covers at least one part of the conductor layer M2. The pixel electrode layer PX is disposed on the insulation layer PV. The filter layer F and the black matrix BM are disposed on the substrate 12. The common electrode layer REF is disposed on the filter layer F and the black matrix BM. The liquid crystal layer LC is disposed between the pixel electrode layer PX and the common electrode layer REF. The first conductor layer M1, for example, is the foregoing light shielding portion CM2 of the common signal line CM. The foregoing second conductor layer M2, for example, includes at least one part of second signal lines. The pixel electrode layer PX, for example, forms at least one pixel electrode by a patterning process. The material of the first conductor layer M1, for example, is a metal or a conductive material with poor light transmission. The material of the second conductor layer M2, for example, is a metal or another material with good conductivity. The materials of the pixel electrode layer PX and the common electrode layer REF, for example, are indium tin oxides (ITO), or other conductive materials with good light transmission. The foregoing is merely illustration, but in fact, this application is not limited thereto.

Then referring to FIG. 4D and FIG. 4E, FIG. 4D is a schematic top view of one pixel unit of a display panel according to still yet another embodiment of the present invention, and FIG. 4E is a schematic top view of one pixel unit of a display panel according to a still further embodiment of the present invention. In the embodiment shown in FIG. 4D and FIG. 4E, a display panel includes a light shielding pattern MT as a part of a light shielding unit. That is, in this embodiment, the light shielding unit is formed by the light shielding pattern MT and at least one part of the second signal line DG. The relative relationship between the light shielding pattern MT and other elements is similar to the relationship between the foregoing light shielding portion CM2 and other elements. The difference is that the light shielding pattern MT is not connected to the common signal line CM. The material or structure of the light shielding pattern MT is opaque or has low light transmission, for example, the light shielding pattern formed by the first conductor layer M1. In FIG. 4D, the light shielding sub-unit has a width WD1′, and in FIG. 4E, the light shielding sub-unit has a width WD2′. From another perspective, the width WD1′ and the width WD2′ are lengths of the light shielding sub-unit in the z axis direction.

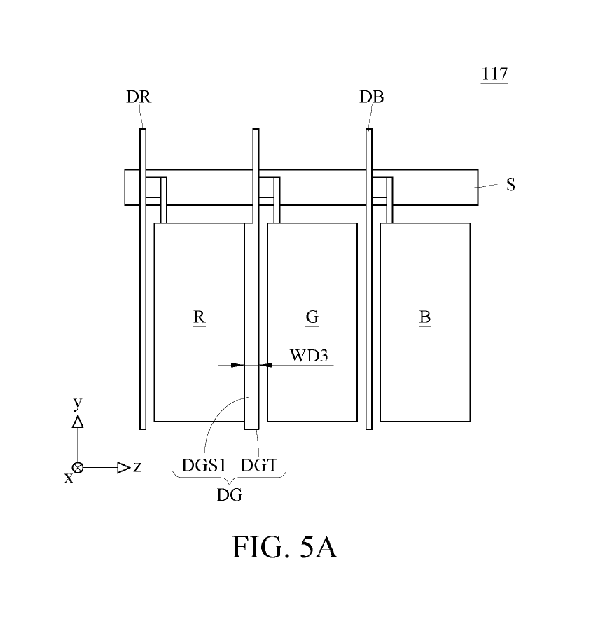

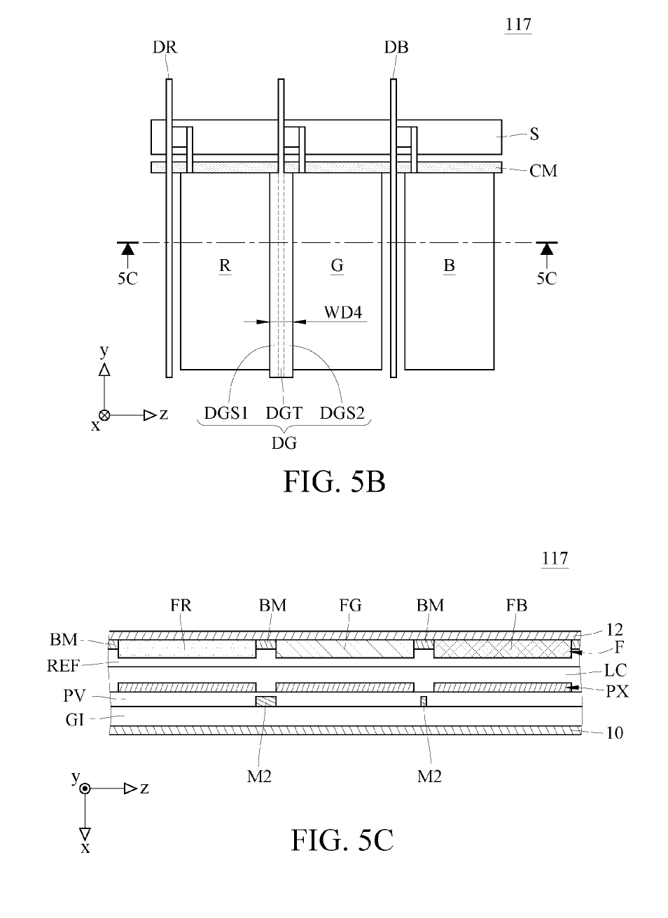

Next, referring to FIG. 5A, FIG. 5B, and FIG. 5C, FIG. 5A, FIG. 5B, and FIG. 5C are used to describe an implementation aspect in which the light shielding unit LS includes at least one part of the second signal lines DR, DG, and DB. FIG. 5A is a schematic top view of one pixel unit of a display panel according to another embodiment of the present invention. FIG. 5B is a schematic top view of one pixel unit of a display panel according to still another embodiment of the present invention. FIG. 5C is a partial schematic cross-sectional view along 5C-5C of the display panel according to FIG. 5B.

In the embodiment shown in FIG. 5A, the second signal line DG includes a transmission portion DGT and a light shielding portion DGS1. The light shielding portion DGS1 is located on one side, adjacent to the first color sub pixel unit R, of the transmission portion DGT. In the embodiment shown in FIG. 5B, the second signal line DG includes a transmission portion DGT and light shielding portions DGS1 and DGS2. The light shielding portions DGS1 and DGS2 are respectively connected to opposite two sides of the transmission portion DGT, and are respectively adjacent to the first color sub pixel unit R and the third color sub pixel unit G. The transmission portion DGT is used to transmit a data voltage. The light shielding sub-unit includes at least one part of the light shielding portions DGS1 and DGS2. In FIG. 5A and FIG. 5B, the shown light shielding portions DGS1 and DGS2, for example, correspond to the light shielding sub-unit LS1 in FIG. 3. In FIG. 5A, one side of the light shielding portion DGS1 is connected to the transmission portion DGT, and the other side of the light shielding portion DGS1 aligns to the edge of the first color filter unit FR in the x axis direction. The x axis direction is a direction parallel to the projection of the substrate 10 or a direction perpendicular to the substrate 10. However, in FIG. 5B, one side of the light shielding portion DGS2 align to the edge of the third color filter unit FG in the x axis direction. From another perspective, if the transmission direction of the transmission portion DGT is a symmetric axis, the light shielding portion DGS1 of FIG. 5A is not symmetric about the symmetric axis, and the light shielding portions DGS1 and DGS2 of FIG. 5B are symmetric about the symmetric axis. In FIG. 5A, the light shielding sub-unit has a width WD3, and in FIG. 5B, the light shielding sub-unit has a width WD4. From another perspective, the width WD3 and the width WD4 are lengths of the light shielding sub-unit in the z axis direction.

However, FIG. 5C shows another AC structure of the display panel in this embodiment by using the 5C-5C cross section in FIG. 5B. A substrate 10, an insulation layer GI, a second conductor layer M2, an insulation layer PV, a pixel electrode layer PX, a liquid crystal layer LC, a common electrode layer REF, a filter layer F, and an opposite substrate 12 are shown in FIG. 5C. The insulation layer GI is disposed on the substrate 10. The second conductor layer M2 is disposed on the insulation layer GI. The second conductor layer M2 includes second signal lines DR, DG, and DB. The insulation layer PV is disposed on the insulation layer GI and on the second conductor layer M2. The insulation layer PV covers at least one part of the second conductor layer M2. The pixel electrode layer PX is disposed on the insulation layer PV. The filter layer F and the black matrix BM are disposed on the substrate 12. The common electrode layer REF is disposed on the filter layer F and the black matrix BM. The liquid crystal layer LC is disposed between the pixel electrode layer PX and the common electrode layer REF. The foregoing second signal lines, for example, include at least one part of second conductor layer M2. The pixel electrode layer PX, for example, forms at least one pixel electrode by a patterning process. The material of the second conductor layer M2, for example, is a metal or another conductive material with poor light transmission. The materials of the pixel electrode layer PX and the common electrode layer REF, for example, are ITOs, or other conductive materials with good light transmission. The foregoing is merely an illustration, but in fact, this application is not limited thereto.

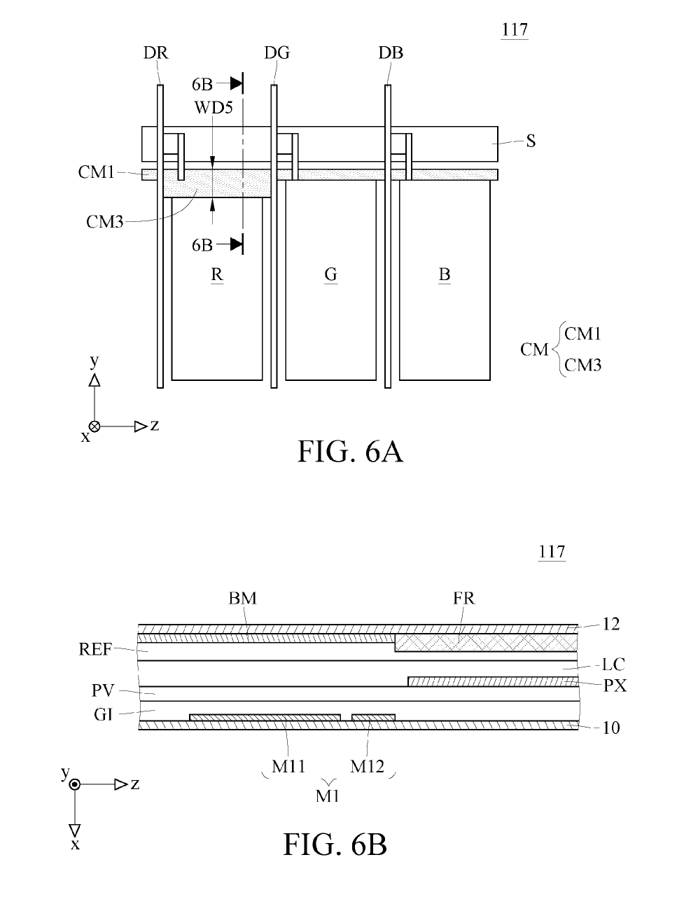

FIG. 4A to FIG. 5C show different embodiments of the display panel 1, in which the curvature center axis of the display panel 1 is parallel to the y axis. Next, referring to FIG. 6A and FIG. 6B, FIG. 6A and FIG. 6B are used to describe an embodiment of the display panel 1 in which the curvature center axis of the display panel 1 is parallel to the z axis. FIG. 6A is a schematic top view of one pixel unit of a display panel according to still yet another embodiment of the present invention. FIG. 6B is a partial schematic cross-sectional view of a 6B-6B cross section of the display panel according to FIG. 6A.

In the embodiment shown in FIG. 6A, a common signal line CM includes a transmission portion CM1 and a light shielding portion CM3, where the transmission portion CM1 and the light shielding portion CM3 both extend along the z direction, and are parallel to the first signal line S. The transmission portion CM1 is used to transmit a common voltage. The light shielding sub-unit includes at least one part of the light shielding portion CM3. In FIG. 6A, one side of the light shielding portion CM3 aligns to the edge of the first color filter unit FR in the x axis direction, and the other side of the light shielding portion CM3 is connected to the transmission portion CM1 in the y axis direction. In FIG. 6A, the light shielding sub-unit has a width WD5. From another perspective, the width WD5 is the length of the light shielding sub-unit in the y axis direction.

FIG. 6B shows a cross-sectional structure of the display panel in this embodiment by using the 6B-6B cross section in FIG. 6A. A substrate 10, a first conductor layer M1, an insulation layer GI, an insulation layer PV, a pixel electrode layer PX, a liquid crystal layer LC, a common electrode layer REF, a filter layer F, and a substrate 12 are shown in FIG. 6B. The conductor layer M1 includes a conductor sub-layer M11 and a conductor sub-layer M12.

The first conductor layer M1 is disposed on the substrate 10. The first conductor layer M1 includes a first signal line S and a common signal line CM. The insulation layer GI is disposed on the substrate 10, and is disposed on the first conductor layer M1. The insulation layer GI covers at least one part of the first conductor layer M1. The insulation layer PV is disposed on the insulation layer GI. The pixel electrode layer PX is disposed on the insulation layer PV. The filter layer F and the black matrix BM are disposed on the substrate 12. The common electrode layer REF is disposed on the filter layer F and the black matrix BM. The liquid crystal layer LC is disposed between the pixel electrode layer PX and the common electrode layer REF. The foregoing first signal line S, for example, includes at least one part of the first conductor sub-layer M11, and the common signal line CM, for example, includes at least one part of the second conductor sub-layer M12. The pixel electrode layer PX, for example, forms at least one pixel electrode by means of a patterning process. The material of the first conductor layer M1, for example, is a metal or another conductive material with poor light transmission. The materials of the pixel electrode layer PX and the common electrode layer REF, for example, are ITOs. The foregoing is merely illustration, but in fact, this application is not limited thereto.

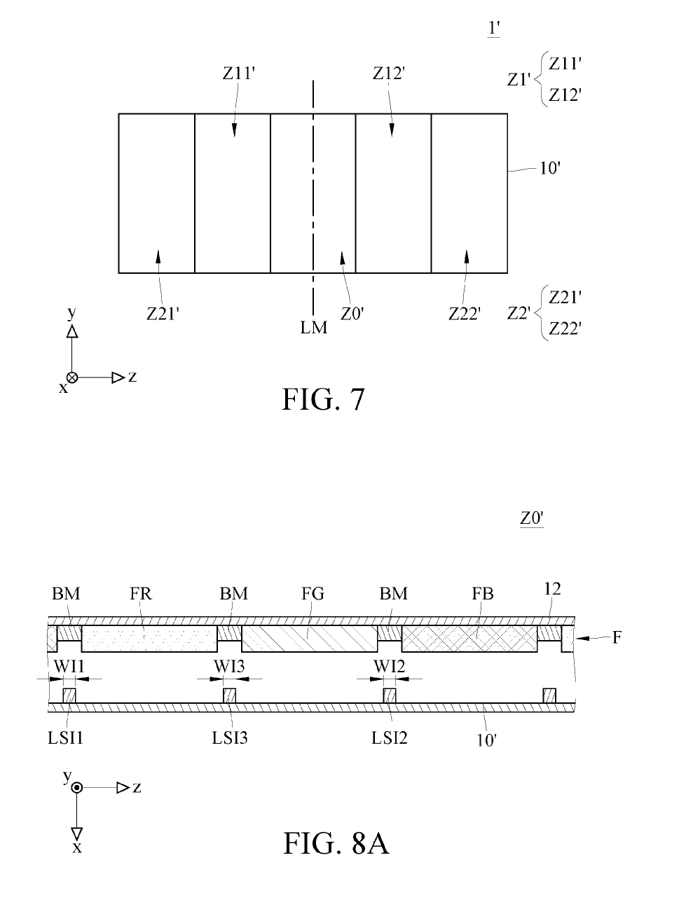

In addition to defining the first compensation area in the display panel to adjust amounts of light emitted from different viewing angles. In different embodiments, other compensation areas may further be defined on the display panel. Next, referring to FIG. 7, FIG. 7 is a schematic diagram of a curve surface of a display panel according to another embodiment of the present invention. In the embodiment shown in FIG. 7, an equivalent front view area Z0′, a first compensation area Z1′, and a second compensation area Z2′ are defined on a substrate 10′ of a display panel 1′. The first compensation area Z′ includes a first compensation first sub area Z11′ and a first compensation second sub area Z12′. The second compensation area Z2′ includes a second compensation first sub area Z21′ and a second compensation second sub area Z22′. The equivalent front view area Z0′ overlaps with a mid line LM in an x axis direction, or, in other words, the equivalent front view area Z0′ overlaps with the mid line LM in a yz plane. The first compensation first sub area Z11′ and the first compensation second sub area Z12′ are respectively located on two sides of the equivalent front view area Z0′ and the mid line LM. The second compensation first sub area Z21′ and the second compensation second sub area Z22′ are respectively located on two sides of the equivalent front view area Z0′ and the mid line LM. The first compensation area Z1′ is located between the equivalent front view area Z0′ and the second compensation area Z2′. For example, the equivalent front view area Z0′ of the curved display panel usually refers to an area, a distance between which and a viewer is shortest or longest with respect to distances between other areas and the viewer.

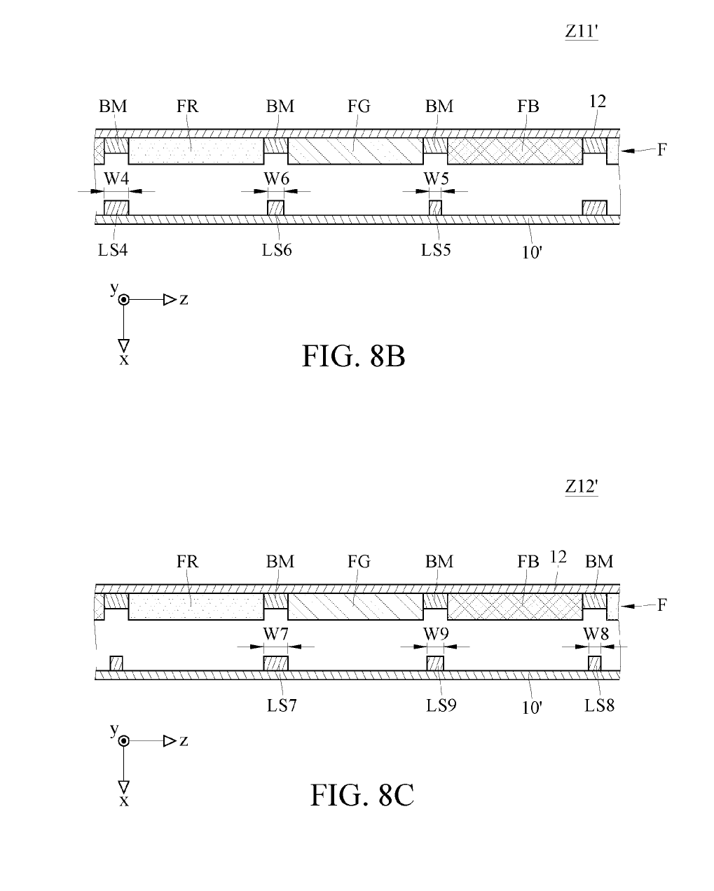

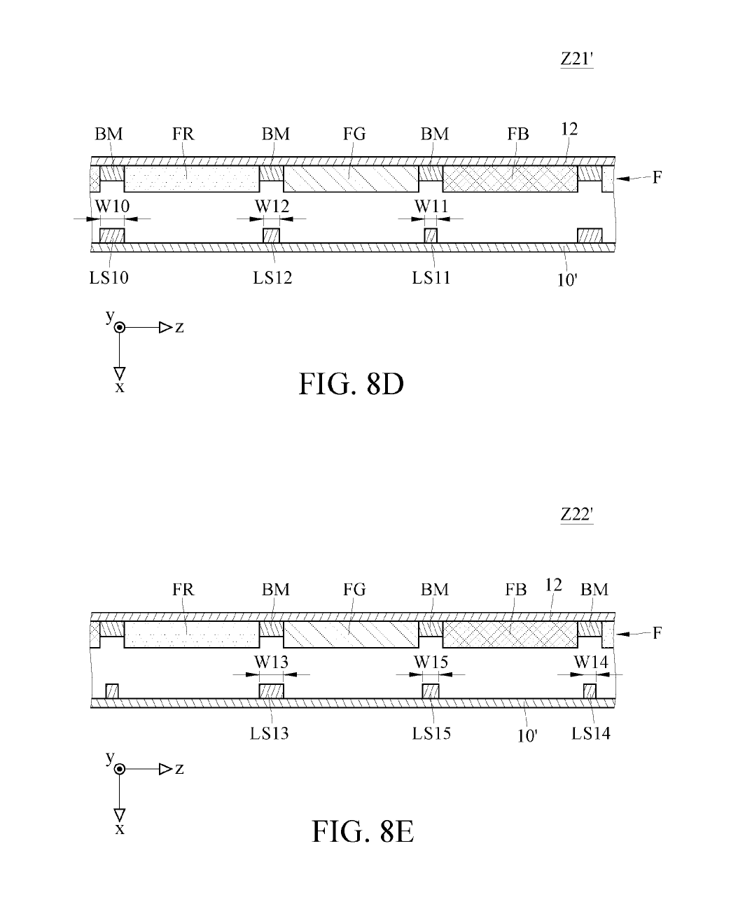

The relative connection relationships among various elements in the equivalent front view area Z0′, the relative connection relationships among various elements in the first compensation area Z1′, and the relative connection relationships among various elements in the second compensation area Z2′ are similar to the relative connection relationships among various elements in the foregoing first compensation area Z1, and related details are not described again. However, in this embodiment, implementation aspects of different light shielding units in different compensation areas are slightly different, and this is respectively described below by using FIG. 8A to FIG. 8E.

Next, referring to FIG. 8A to FIG. 8E, FIG. 8A is a schematic diagram of a light shielding unit corresponding to the equivalent front view area Z0′ according to FIG. 7. FIG. 8B is a schematic diagram of a light shielding unit corresponding to a first compensation first sub area Z11′ according to FIG. 7. FIG. 8C is a schematic diagram of a light shielding unit corresponding to a first compensation second sub area Z12′ according to FIG. 7. FIG. 8D is a schematic diagram of a light shielding unit corresponding to a second compensation first sub area Z21′ according to FIG. 7. FIG. 8E is a schematic diagram of a light shielding unit corresponding to a second compensation second sub area Z22′ according to FIG. 7.

As shown in FIG. 8A, a viewing angle corresponding to the equivalent front view area Z0′ is relatively small, and is approximately 0 degrees, and therefore the problem of color shift does not exist. Therefore, in this embodiment, in the equivalent front view area Z0′, the width WI1 of the first light shielding sub-unit LSI1, the width WI2 of the second light shielding sub-unit LSI2, and the width WI3 of the third light shielding sub-unit are substantially equal to each other. That is, in the equivalent front view area Z0′, sub pixels of different colors are not respectively compensated.

As shown in FIG. 8B, in the first compensation first sub area Z11′, the mid line LM, for example, is located on the right side of the first compensation first sub area Z11′, and the first light shielding sub-unit LS4 is located on a side edge, far from the mid line LM, of the first color sub pixel unit R, for example, the left side. Similarly, the second light shielding sub-unit LS5 is located on a side edge, far from the mid line, of the second color sub pixel unit B, and the third light shielding sub-unit LS6 is located on a side edge, far from the mid line LM, of the third color sub pixel unit G. The width W4 of the first light shielding sub-unit LS4 is greater than the width W6 of the third light shielding sub-unit LS6, and the width W6 of the third light shielding sub-unit LS6 is greater than the width W5 of the second light shielding sub-unit LS5. As shown in FIG. 8C, in the first compensation second sub area Z12′, the mid line LM, for example, is located on the left side of the first compensation second sub area Z12′, and the first light shielding sub-unit LS7 is located on a side edge, far from the mid line LM, of the first color sub pixel unit R, for example, the right side. Similarly, the second light shielding sub-unit LS8 is located on a side edge, far from the mid line, of the second color sub pixel unit B, and the third light shielding sub-unit LS9 is located on a side edge, far from the mid line LM, of the third color sub pixel unit G. The width W7 of the first light shielding sub-unit LS7 is greater than the width W9 of the third light shielding sub-unit LS9, and the width W9 of the third light shielding sub-unit LS9 is greater than the width W8 of the second light shielding sub-unit LS8.

As shown in FIG. 8D, in the second compensation first sub area Z21′, the mid line LM, for example, is located on the right side of the second compensation first sub area Z21′, and the first light shielding sub-unit LS10 is located on a side edge, far from the mid line LM, of the first color sub pixel unit R, for example, the left side. Similarly, the second light shielding sub-unit LS11 is located on a side edge, far from the mid line, of the second color sub pixel unit B, and the third light shielding sub-unit LS12 is located on a side edge, far from the mid line LM, of the third color sub pixel unit G. The width W10 of the first light shielding sub-unit LS10 is greater than the width W12 of the third light shielding sub-unit LS12, and the width W12 of the third light shielding sub-unit LS12 is greater than the width W11 of the second light shielding sub-unit LS11. As shown in FIG. 8E, in the second compensation second sub area Z22′, the mid line LM, for example, is located on the left side of the second compensation second sub area Z22′, and the first light shielding sub-unit LS13 is located on a side edge, far from the mid line LM, of the first color sub pixel unit R, for example, the right side. Similarly, the second light shielding sub-unit LS14 is located on a side edge, far from the mid line, of the second color sub pixel unit B, and the third light shielding sub-unit LS15 is located on a side edge, far from the mid line LM, of the third color sub pixel unit G. The width W13 of the first light shielding sub-unit LS13 is greater than the width W15 of the third light shielding sub-unit LS15, and the width W15 of the third light shielding sub-unit LS15 is greater than the width W14 of the second light shielding sub-unit LS14.

In addition, because the second compensation area Z2′ is farther from the mid line LM than the first compensation area Z1, the width W10 of the first light shielding sub-unit LS10 of the second compensation first sub area Z21′ is greater than the width W4 of the first light shielding sub-unit LS4 of the first compensation first sub area Z11′, and the width W11 of the second light shielding sub-unit LS11 of the second compensation first sub area Z21′ is greater than the width W5 of the second light shielding sub-unit of the first compensation first sub area Z11′. The width W12 of the third light shielding sub-unit LS12 of the second compensation first sub area Z21′ is greater than the width W6 of the third light shielding sub-unit LS6 of the first compensation first sub area Z11′. The width W13 of the first light shielding sub-unit LS13 of the second compensation second sub area Z22′ is greater than the width W7 of the first light shielding sub-unit LS7 of the first compensation second sub area Z12′. The width W14 of the second light shielding sub-unit LS14 of the second compensation second sub area Z22′ is greater than the width W8 of the second light shielding sub-unit LS8 of the first compensation second sub area Z12′. The width W15 of the third light shielding sub-unit LS15 of the second compensation second sub area Z22′ is greater than the width W9 of the third light shielding sub-unit LS9 of the first compensation second sub area Z12′.

That is, the widths W10 and W13 of the first light shielding sub-units LS10 and LS13 of Z21′ and Z22′ of the second compensation area are greater than the widths W4 and W7 of the first light shielding sub-units LS4 and LS7 of Z11′ and Z12′ of the first compensation area. The widths W11 and W14 of the second light shielding sub-units LS11 and LS14 of Z21′ and Z22′ of the second compensation area are greater than the widths W5 and W8 of the second light shielding sub-units LS5 and LS8 of Z11′ and Z12′ of the first compensation area. The widths W12 and W15 of the third light shielding sub-units LS12 and LS15 of Z21′ and Z22′ of the second compensation area are greater than the widths W6 and W9 of the third light shielding sub-units LS6 and LS9 of Z11′ and Z12′ of the first compensation area.

It should be noted that the foregoing figures are only used for illustration. Except for relative sizes, the relative proportions between widths of the light shielding sub-units in the first compensation area Z1′ are not limited herein, and it is not limited either whether each light shielding sub-unit in the first compensation area Z1′ is completely located in an orthographic projection of the black matrix BM on the substrate 10′.

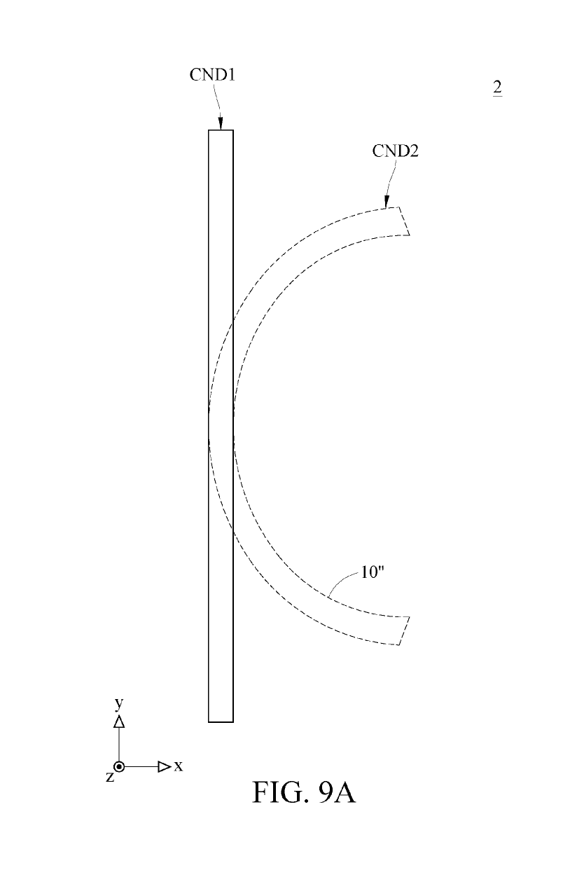

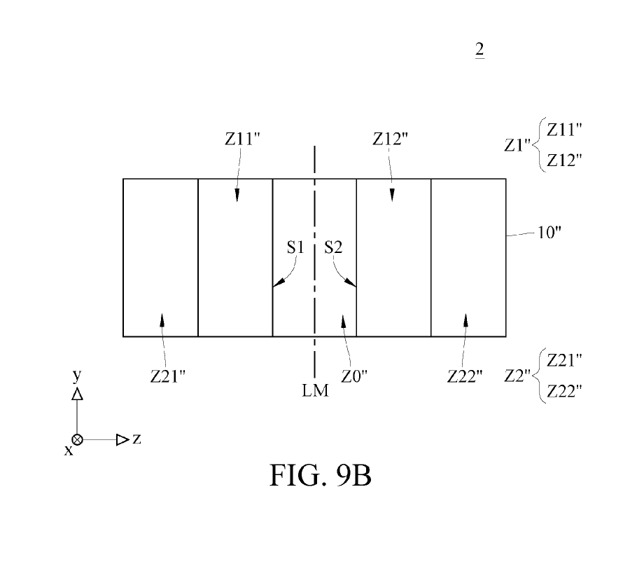

Next, referring to FIG. 9A and FIG. 9B, FIG. 9A is a schematic diagram of a display panel according to another embodiment of the present invention, and FIG. 9B is a schematic diagram of a curved surface of the display panel according to FIG. 9A. Compared with the display panel 1 having the curved surface SC shown in FIG. 1A, in the embodiment shown in FIG. 9, a display panel 2 is a flexible display panel. The display panel 2 can deform between a first state CND1 and a second state CND2 upon an external force. The first state CND1, for example, is a planar shape, and the second state CND2, for example, is a shape similar to that of the display panel 1 shown in FIG. 1A, and related details are not described again. In this embodiment, only the first state CND1 and the second state CND2 are illustrated. However, in fact, the display panel 2 may further have other states. In addition, the first state CND1 and the second state CND2 are not limited to the planar shape or flexible shape in the figure, or may be a waved shape or have an obvious included angle. It is not limited herein which states the first state CND1 and the second state CND2 are. Any state in which there is at least one curvature center belongs to the range of the second state CND2.

In addition to performing deformation upon an external force, the connection relationships among elements and working manners of the elements of the display panel 2 are similar to those of the foregoing display panel 1 or display panel 1′. From another perspective, for the display panel 2 in this embodiment, an equivalent front view area Z0″, a first compensation first sub area Z11′, and a first compensation second sub area Z12″ are defined on a substrate 10″. The equivalent front view area Z0″ is located between the first compensation first sub area Z11″ and the first compensation second sub area Z12″. The equivalent front view area Z0″ includes a first side S1 and a second side S2. The first compensation first sub area Z11″ is adjacent to the first side S1. The first compensation second sub area Z12′ is adjacent to the second side S2. In each compensation area, there is at least one light shielding unit located on the substrate 10″. The light shielding unit includes a first light shielding sub-unit and a second light shielding sub-unit. The first light shielding sub-unit is located on a side edge, far from the equivalent front view area Z0″, of the first color sub pixel unit, and the second light shielding sub-unit is located on a side edge, far from the equivalent front view area Z0″, of the second color sub pixel unit. In the first compensation first sub area Z11″ and the first compensation second sub area Z12″, the width of the first light shielding sub-unit is not equal to the width of the second light shielding sub-unit. The relative connection relationships among various elements in the equivalent front view area Z0″, the relative connection relationships among various elements in the first compensation area Z1″, and the relative connection relationships among various elements in the second compensation area Z2″ are similar to those in the foregoing embodiment, and related details are not described again.

Based on the above, the present invention provides a plurality of display panels. By disposing a light shielding unit on a substrate, an excessive amount of light is prevented from being output from sub pixels of an area with a relatively large viewing angle. The light shielding unit includes a first light shielding sub-unit and a second light shielding sub-unit. The first light shielding sub-unit and the second light shielding sub-unit are respectively located on a side edge, far from a mid line, of a first color sub pixel unit and a side edge, far from the mid line, of a second color sub pixel unit. In addition, in a first compensation area, the width of the first light shielding sub-unit is not equal to the width of the second light shielding sub-unit, to separately adjust the amount of light that passes through different sub pixel units. In this way, the problem that color shift easily occurs in a large viewing angle area of a curved display or a flexible display is avoided.

Although the present disclosure has been described by using the foregoing implementations, is the implementations are not used to limit the present invention. A person skilled in the art can make various modifications and improvements without departing from the spirit and scope of the present disclosure. Therefore, the protection scope of the present disclosure should be subject to the scope defined by the appended claims.

What is claimed is:

1. A display panel, comprising:
a substrate, having a curved surface, wherein the curved surface has a curvature center axis, and a mid line is defined on the curved surface; the mid line is parallel to the curvature center axis, and a first compensation area located on a side of the mid line is defined on the substrate;
a pixel unit, located in the first compensation area of the substrate, wherein the pixel unit comprises a first color sub pixel unit and a second color sub pixel unit; and
a light shielding unit, located on the substrate, wherein the light emitting unit comprises a first light shielding sub-unit and a second light shielding sub-unit, the first light shielding sub-unit is located on a side edge, far from the mid line, of the first color sub pixel unit, and the second light shielding sub-unit is located on a side edge, far from the mid line, of the second color sub pixel unit, wherein
in the first compensation area, a width of the first light shielding sub-unit is not equal to a width of the second light shielding sub-unit.

2. The display panel according to claim 1, wherein in the first compensation area, the width of the first light shielding sub-unit is greater than the width of the second light shielding sub-unit.

3. The display panel according to claim 2, wherein the pixel unit further comprises a third color sub pixel unit, and the light shielding unit further comprises a third light shielding sub-unit, the third color sub pixel unit is located between the first color sub pixel unit and the second color sub pixel unit, the third light shielding sub-unit is located on a side edge, far from the mid line, of the third color sub pixel unit, and in the first compensation area, the width of the first light shielding sub-unit is greater than a width of the third light shielding sub-unit, and the width of the third light shielding sub-unit is greater than the width of the second light shielding sub-unit.

4. The display panel according to claim 3, wherein an equivalent front view area is further defined on the substrate, the equivalent front view area overlaps with the mid line in a direction perpendicular to the substrate, the display panel further comprises a second pixel unit and a second light shielding unit located in the equivalent front view area of the substrate, and a width of a first light shielding sub-unit, a width of a second light shielding sub-unit, and a width of a third light shielding sub-unit of the second light shielding unit are substantially the same.

5. The display panel according to claim 3, wherein a second compensation area is further defined on the substrate, the first compensation area is located between the equivalent front view area and the second compensation area, the display panel further comprises a third pixel unit and a third light shielding unit located in the second compensation area of the substrate, a width of a first light shielding sub-unit of the third light shielding unit is greater than a width of a third light shielding sub-unit, and the width of the third light shielding sub-unit is greater than a width of a second light shielding sub-unit, and the width of the first light shielding sub-unit of the second compensation area is greater than the width of the first light shielding sub-unit of the first compensation area.

6. The display panel according to claim 2, wherein the first color sub pixel unit is a red sub pixel unit, and the second color sub pixel unit is a blue sub pixel unit.

7. The display panel according to claim 3, wherein the first color sub pixel unit is a red sub pixel unit, the second color sub pixel unit is a blue sub pixel unit, and the third color sub pixel unit is a green sub pixel unit.

8. The display panel according to claim 1, further comprising:
a plurality of first signal lines, disposed on the substrate, and for transmitting a gate driving signal;
a plurality of second signal lines, disposed on the substrate, and for transmitting a data signal, and the second signal lines intersecting with the first signal lines; and
a plurality of common signal lines, disposed on the substrate, and for transmitting a common voltage, wherein the common signal lines has an extension direction parallel to an extension direction of the first signal lines or an extension direction of the second signal lines, and
the light shielding unit comprises at least one part of the first signal lines, at least one part of the second signal lines, or at least one part of the common signal lines.

9. The display panel according to claim 8, wherein the light shielding unit comprises at least one part of the second signal lines and at least one part of the common signal lines.

10. The display panel according to claim 8, wherein the light shielding unit comprises at least one part of the first signal lines and at least one part of the common signal lines.

11. A display panel, comprising:
a substrate, wherein an equivalent front view area, a first compensation first sub area, and a first compensation second sub area are defined on the substrate, and the equivalent front view area is located between the first compensation first sub area and the first compensation second sub area;
a plurality of pixel units, located on the substrate, wherein each pixel unit comprises a first color sub pixel unit and a second color sub pixel unit; and
a plurality of light shielding units, disposed on the substrate, wherein each light shielding unit is disposed corresponding to a pixel unit, and each light shielding unit comprises a first light shielding sub-unit and a second light shielding sub-unit, and the first light shielding sub-unit and the second light shielding sub-unit are respectively located on a side edge of the first color sub pixel unit and a side edge of the second color sub pixel unit;
wherein, in the light shielding unit of the first compensation first sub area, a width of the first light shielding sub-unit is not equal to a width of the second light shielding sub-unit; in the light shielding unit of the first compensation second sub area, a width of the first light shielding sub-unit is not equal to a width of the second light shielding sub-unit, and the first light shielding sub-units are respectively located on side edges, far from the equivalent front view area, of the first color sub pixel units, and the second light shielding sub-units are respectively located on side edges, far from the equivalent front view area, of the second color sub pixel units; and
in the light shielding unit of the equivalent front view area, a width of the first light shielding sub-unit is substantially equal to a width of the second light shielding sub-unit.

12. The display panel according to claim 11, wherein in the light shielding unit of the first compensation first sub area, the width of the first light shielding sub-unit is greater than the width of the second light shielding sub-unit; and in the light shielding unit of the first compensation second sub area, the width of the first light shielding sub-unit is greater than the width of the second light shielding sub-unit.

13. The display panel according to claim 12, wherein each of the light shielding units further comprises a third light shielding sub-unit, and each of the pixel units further comprises a third color sub pixel unit, and the third light shielding sub-unit is located on a side edge of the third color sub pixel;
in the equivalent front view area, widths of the light shielding sub-units are the same;
in the first compensation first sub area, a width of the third light shielding sub-unit is greater than the width of the second light shielding sub-unit, and the width of the first light shielding sub-unit is greater than the width of the third light shielding sub-unit; and
in the first compensation second sub area, a width of the third light shielding sub-unit is greater than the width of the second light shielding sub-unit, and the width of the first light shielding sub-unit is greater than the width of the third light shielding sub-unit.

14. The display panel according to claim 13, wherein a second compensation first sub area and a second compensation second sub area are further defined on the substrate; the first compensation first sub area is located between the second compensation first sub area and the equivalent front view area; the first compensation second sub area is located between the second compensation second sub area and the equivalent front view area, and a width of a second light shielding sub-unit of the second compensation first sub area is greater than the width of the second light shielding sub-unit of the first compensation first sub area, and
a width of the first light shielding sub-unit of the second compensation first sub area is greater than the width of the first light shielding sub-unit of the first compensation first sub area.

15. The display panel according to claim 11, wherein the first color sub pixel unit is a red sub pixel unit and the second color sub pixel unit is a blue sub pixel unit.

16. The display panel according to claim 13, wherein the first color sub pixel unit is a red sub pixel unit, the second color sub pixel unit is a blue sub pixel unit, and the third color sub pixel unit is a green sub pixel unit.

17. The display panel according to claim 11, wherein the equivalent front view area is substantially located in the center of the substrate.

18. The display panel according to claim 11, further comprising:
a plurality of first signal lines, disposed on the substrate, and for transmitting a gate drive signal;
a plurality of second signal lines, disposed on the substrate, and for transmitting a data signal, and the second signal lines intersect with the first signal lines; and
a plurality of common signal lines, disposed on the substrate, and for transmitting a common voltage, wherein the common signal lines comprise an extension direction parallel to an extension direction of the first signal lines or an extension direction of the second signal lines, and
the light shielding unit comprises at least one part of the first signal lines, at least one part of the second signal lines, or at least one part of the common signal lines.
